(19) United States
(12) Patent Application Publication
(10) Pub. No.: US 2015/0355687 A1
(43) Pub. Date: Dec. 10, 2015

(54) COMPUTER SCREEN

(71) Applicant: BENQ CORPORATION, Taipei City (TW)

(72) Inventor: Chin-Fu Chiang, New Taipei City (TW)

(73) Assignee: BENQ CORPORATION, Taipei City (TW)

(21) Appl. No.: 14/679,033

(22) Filed: Apr. 6, 2015

(30) Foreign Application Priority Data
Jun. 9, 2014 (TW) 103119901

(51) Int. Cl. G06F 1/18; G06F 1/16

(52) U.S. Cl. CPC G06F 1/189; G06F 1/1601; G06F 2200/1612

(57) ABSTRACT

A computer screen comprising a body, a base and a power transmission line is provided. The body comprises a display panel. The base comprises a connecting part, a supporting part, and a transformer. The body is detachably disposed on the base. The transformer, connected to an alternating current (AC) power source for electrically connecting to the body selectively, is disposed inside the supporting part for transforming an AC voltage of the AC power source to a direct current (DC) voltage. The connecting part detachably connects the body and the supporting part. The power transmission line detachably connects the body and the supporting part for transmitting the DC voltage to the body.

This application claims the benefit of Taiwan application Serial No. 103119901, filed Jun. 9, 2014, the subject matter of which is incorporated herein by reference.

### BACKGROUND OF THE INVENTION

1. Field of the Invention

The invention relates in general to a computer screen, and more particularly to a computer screen whose body is detachably disposed on the base.

2. Description of the Related Art

Conventional computer screen normally transforms an alternating current (AC) voltage to a direct current (DC) voltage that can be applied to the computer screen by using an external accessory such as a transformer. However, conventional external transformer is big and heavy, occupies a large space and causes inconvenience to the use. Additionally, conventional external transformer lacks of aesthetic attraction.

Therefore, in response to consumers' requirements of computer screen, that is, lighter weight, thinner thickness, lower delivery cost and better aesthetic attraction, the structure of the generally known computer screen needs to be improved to satisfy multivariate design requirements.

### SUMMARY OF THE INVENTION

The invention is directed to a computer screen for resolving the foregoing structural problems.

According to one embodiment of the present invention, a computer screen comprising a body, a base and a power transmission line is provided. The body comprises a display panel. The base comprises a connecting part, a supporting part and a transformer. The body is detachably disposed on the base. The transformer, connected to an alternating current (AC) power source for electrically connecting the body selectively, is disposed inside the supporting part for transforming an AC voltage of the AC power source to a direct current (DC) voltage. The connecting part detachably connects the body and the supporting part. The power transmission line detachably connects the body and the supporting part for transmitting the DC voltage to the body.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A is a 3D diagram of a computer screen according to an embodiment of the invention.

FIG. 1B is a decomposition diagram of the computer screen of FIG. 1A.

FIG. 2 is a schematic diagram of another implementation of a connecting part according to an embodiment of the invention.

FIG. 3A is a schematic diagram of an alternate implementation of a connecting part according to an embodiment of the invention.

FIG. 3B is a schematic diagram of a connecting part with a power transmission line embedded in a groove.

FIG. 4 is a schematic diagram of a computer screen according to another embodiment of the invention.

FIG. 5 is a schematic diagram of a computer screen according to an alternate embodiment of the invention.

### DETAILED DESCRIPTION OF THE INVENTION

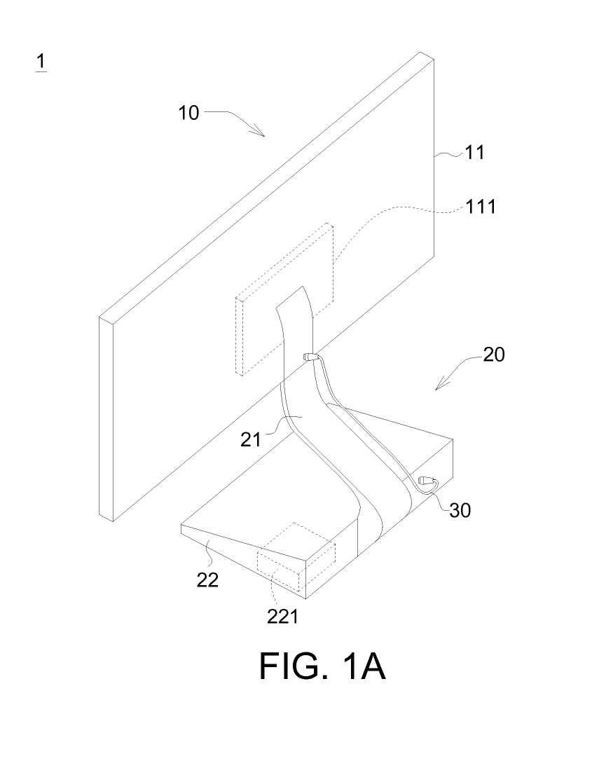

Refer to FIGS. 1A and 1B. FIG. 1A is a 3D diagram of a computer screen 1 according to an embodiment of the invention. FIG. 1B is a decomposition diagram of the computer screen 1 of FIG. 1A. The computer screen 1 of the present embodiment comprises a body 10, a base 20 and a power transmission line 30. The body 10 comprises a display panel 11. The base 20 comprises a connecting part 21, a supporting part 22 and a transformer 221. The body 10 is detachably disposed on the base 20. The transformer 221, connected to an alternating current (AC) power source (not illustrated) for electrically connecting the body 10 selectively, is disposed inside the supporting part 22 for transforming an AC voltage of the AC power source to a direct current (DC) voltage. The connecting part 21 detachably connects the body 10 and the supporting part 22. The power transmission line 30 detachably connects the body 10 and the supporting part 22 for transmitting the DC voltage to the body 10.

To put it in greater details, when the computer screen 1 is electrically connected to a computer host (not illustrated), the display panel 11 of the body 10 displays a frame. The body 10 is connected to the supporting part 22 via the connecting part 21, such that the connecting part 21 and the supporting part 22 can support the body 10 and allow the computer screen 1 to be stably placed on a plane such as a desk-top. Before the computer screen 1 leaves the factory, the body 10, the connecting part 21 and the supporting part 22 are detached from each other such that the volume of the package (such as a carton) can be reduced. Since the package volume is reduced, the number of packages delivered per delivery can be increased.

Since the body 10 and the supporting part 22 can be detachably assembled by the connecting part 21, the delivery space can be reduced and the delivery cost can be cut down accordingly.

The design of detachably assembling the body 10 and the supporting part 22 by the connecting part 21 can be realized by ordinary fasteners or couplers, and details are not touched here. However, the detachable assembly of the invention is not limited thereto, and any forms of detachable assembly will do as long as the connection between the body 10 and the connecting part 21 is detachable and so is the connection between the connecting part 21 and the supporting part 22.

Since the transformer 221 of the present embodiment is disposed inside the supporting part 22, the transformer 221 is hidden inside the supporting part 22 and does not occupy extra space. Therefore, the disadvantages of the conventional external transformer being heavy and big, occupying a large space and lacking aesthetic attraction can be avoided.

When the power transmission line 30 connects the body 10 and the supporting part 22, one end of the transformer 221 is electrically connected to the power transmission line 30. One end of the transformer 221 is connected to a main supply (not illustrated) for receiving an AC power source, and the other end of the transformer 221 is electrically connected to the power transmission line 30 selectively. Here “selectively” refers to the other end of the transformer 221 can either be electrically connected to the power transmission line 30 or not electrically connected to the power transmission line 30. For example, the other end of the transformer 221 is electrically connected to the power transmission line 30 during normal operation but is not electrically connected to the power transmission line 30 when the computer monitor is packaged for delivery. The DC voltage outputted by the transformer 221 is transmitted to the body 10 via the power transmission line 30. The DC voltage of the DC power source outputted by the transformer 221 can be determined according to actual needs or the model of the display panel 11 of the body 10. The transformer 221 can be designed as a DC power source capable of providing various voltages. The length of the power transmission line 30 is not particularly specified in the present invention, and any length allowing the power transmission line 30 to connect the body 10 and the supporting part 22 will do. The power transmission line 30 does not need to be too long, such that the space occupied by the power transmission line 30 can be reduced lest the power transmission line 30 being too long might spoil the aesthetics of the computer screen 1. When the computer screen 1 is packaged for delivery, the power transmission line 30 can be detached from the body 10 and the supporting part 22 to facilitate packaging.

Through the use of the detachable power transmission line 30, electrical connection is not required between the body 10 and the connecting part 21 or between the connecting part 21 and the supporting part 22. Since the body 10, the connecting part 21 and the supporting part 22 without electrical connection are easier to design and manufacture, and can be easily detached and assembled, the problem of the inconvenience and higher delivery cost associated with a non-detachable computer screen is avoided.

Besides, the design of disposing the transformer 221 of the present embodiment on the supporting part 22 further increases the weight of the supporting part 22 and makes the supporting part 22 more stable. In comparison to a generally known base, the supporting part 22 of the present embodiment is formed of less material but provides sufficient weight to stably support the body 11. Therefore, the design of the present embodiment further reduces the volume of the supporting part 22 to save cost. Moreover, the structure of the transformer 221 of the present embodiment can be suitably expanded to match the appearance design of the supporting part 22 and allow the weight of the transformer 221 to be uniformly distributed over the supporting part 22 to increase the supporting stability of the supporting part 22.

Refer to FIG. 1A and FIG. 1B. The body 10 further comprises an image processing plate 111. The image processing plate 111 processes an image display signal and further displays the processed image display signal on the display panel 11.

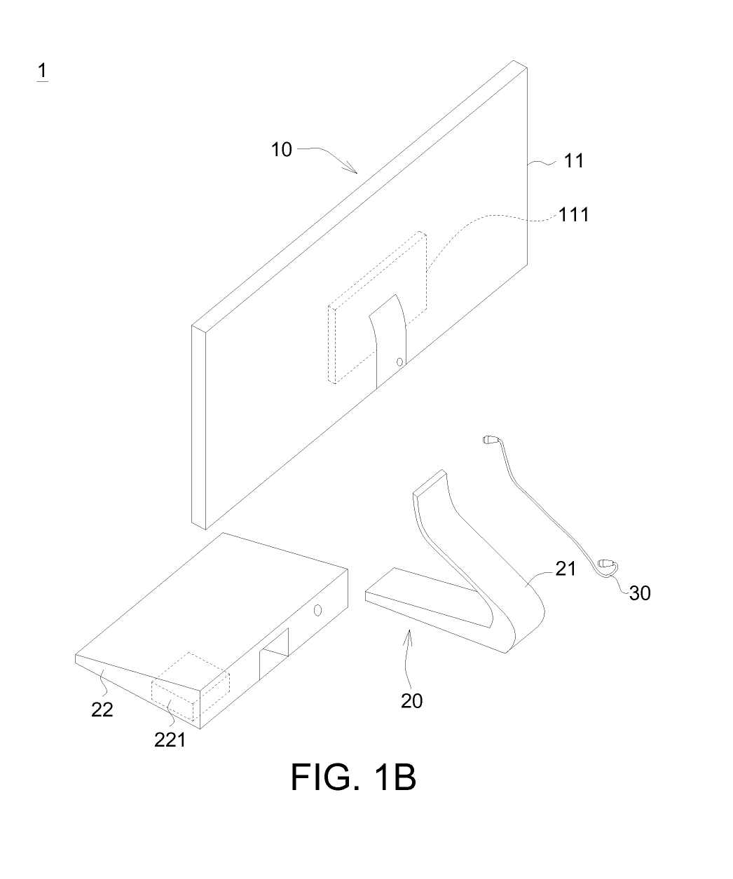

Referring to FIG. 2, a schematic diagram of another implementation of a connecting part according to an embodiment of the invention is shown. As indicated in FIG. 2, a portion of the power transmission line 30 can be directly buried in the connecting part 21A, and only two ends of the power transmission line 30 are exposed outside the connecting part 21A. Such design reduces the exposed portion of the power transmission line 30 and increased the overall aesthetics of the computer screen 1. According to the present implementation, the two ends of the power transmission line 30 are connected to the body 10 and the supporting part 22 respectively when the connecting part 21A connects the body 10 and the supporting part 22.

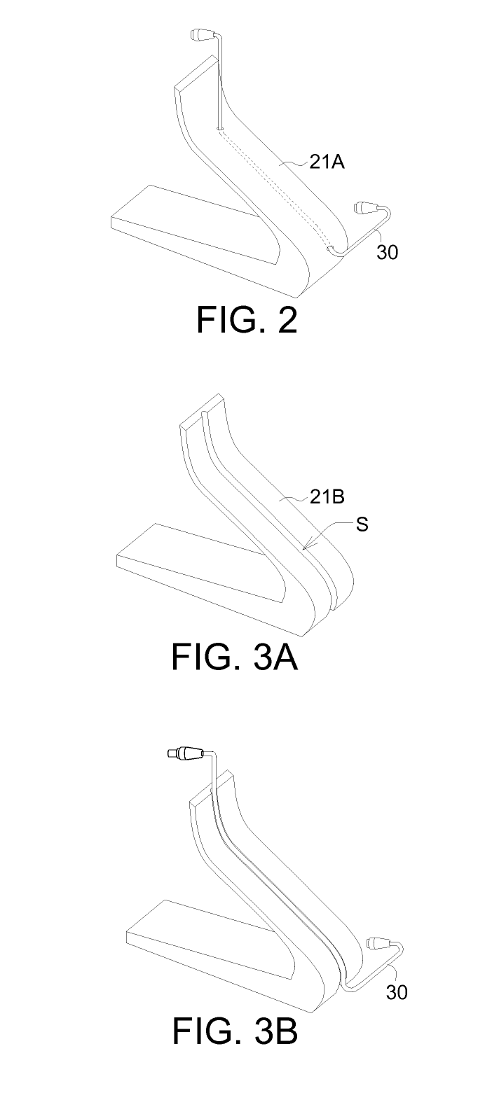

Referring to FIG. 3A, a schematic diagram of an alternate implementation of a connecting part according to an embodiment of the invention is shown. As indicated in FIG. 3A, a surface of the connecting part 21B has a groove S in which the power transmission line 30 is detachably embedded. After the power transmission line 30 is embedded in the groove S, the connecting part 21B is shown as indicated in FIG. 3B. It is understood that the connection between the power transmission line 30 and the connecting part is not limited to groove. Other types of accommodating device or fastening device can be disposed on the connecting part for receiving or fixing the power transmission line 30 on the connecting part. Any design would do as long as at least a portion of the power transmission line 30 is detachably or fixedly disposed on the connecting part.

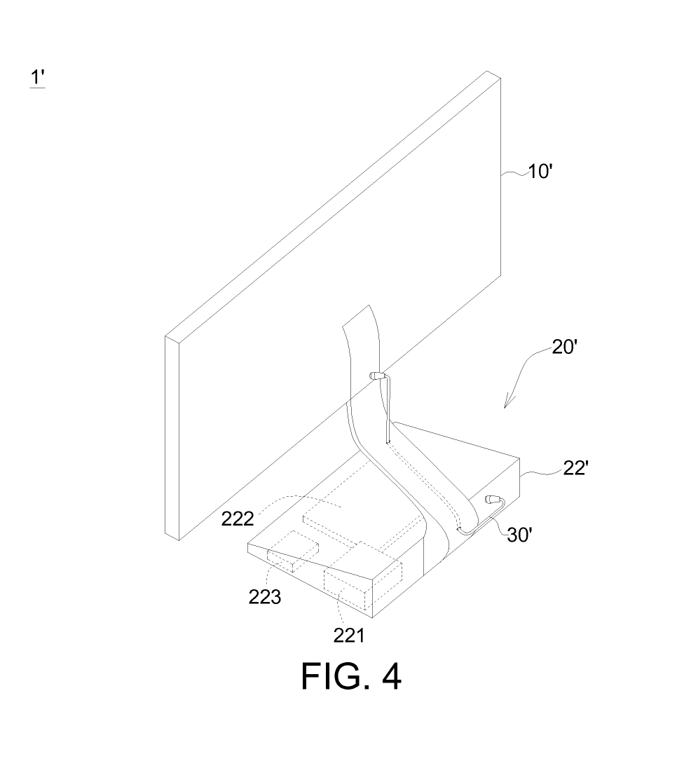

Referring to FIG. 4, a schematic diagram of a computer screen according to another embodiment of the invention is shown. Unlike the previous embodiment, the computer screen 1′ has an image processing plate 222 disposed inside the supporting part 22′. The image processing plate 222 processes an image display signal. The power transmission line 30′ further has the function of the image transmission line for transmitting the image display signal which has been processed by the image processing plate 222 to the body 10′. In the present embodiment, an image transmission line (not illustrated in the diagram) other than the power transmission line 30′ can be disposed for transmitting the image display signal which has been processed by the image processing plate 222 to the body 10′. Thus, the structure of the body 10′ can be made lighter and thinner.

Additionally, as indicated in FIG. 4, the computer screen 1′ further comprises an antenna component 223 disposed inside the supporting part 22′. The antenna component 223 can be electrically connected to the image processing plate 222. If the antenna component (for receiving/transmitting wireless signals) is disposed behind the display panel, the wireless signals to be received/transmitted by the antenna component will be blocked or interfered with by the display panel, and the intensity of the signals will be weakened, and the performance of the antenna component in receiving/transmitting signals will deteriorate. In the present embodiment, the design of disposing the antenna component 223 inside the supporting part 22′ avoids the reception/transmission of signals being blocked or interfered with by the display panel, the intensity of signals being weakened and the performance of the antenna component 223 in receiving/transmitting signals deteriorating.

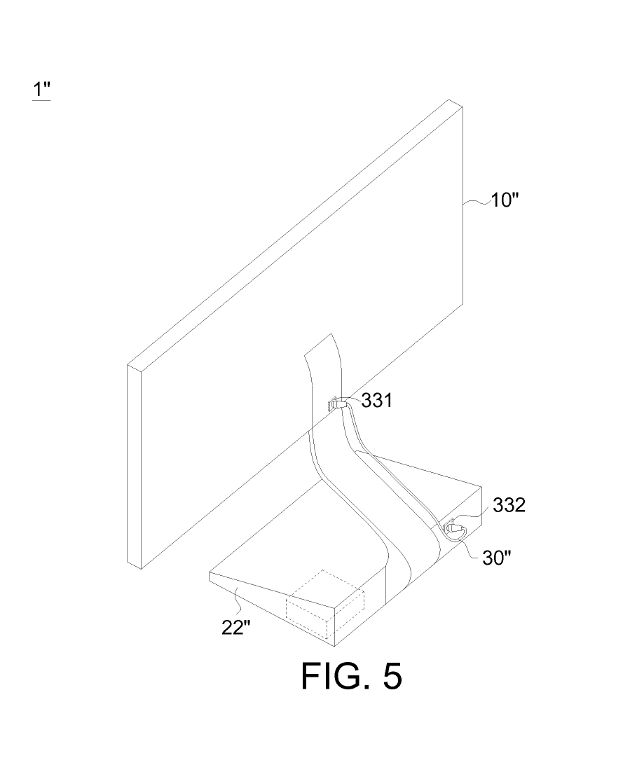

Referring to FIG. 5, a schematic diagram of a computer screen according to an alternate embodiment of the invention is shown. Unlike the previous embodiments, the present embodiment uses an integrated power/signal transmission line 30″. The computer screen 1″ of the present embodiment further comprises a first adapter 331 and a second adapter 332 disposed on the body 10″ and the supporting part 22″ respectively. The integrated power/signal transmission line 30″ detachably connects the first adapter 331 and the second adapter 332 respectively. The integrated power/signal transmission line 30″ can concurrently transmit power and signals. One end of the first adapter 331 is electrically connected to the integrated power/signal transmission line 30″, and the other end respectively transforms and/or outputs the power and the signal transmitted by the integrated power/signal transmission line 30″ to a corresponding power module or a corresponding signal receiving module of the body 10″. One end of the second adapter 332 respectively receives a power and a signal. The second adapter 332 further integrates the received power and signal. The other end of the second adapter 332 further outputs the integrated power and signal to the integrated power/signal transmission line 30″. The integrated power/signal transmission line 30″ can have various implementations. For example, the integrated power/signal transmission line 30″ has a power transmission line and a signal transmission line, wherein the two lines are wrapped by the same wrapping layer and share the same plugs for connecting the adapters. Or, the integrated power/signal transmission line 30″ only has a transmission line. After the second adapter 332 modulates or transforms the received power and signal, the modulated or transformed power and signal can be transmitted via the transmission line. The term “integration” refers to the integration of power and signal according to the design of the integrated power/signal transmission line 30″. Through the design of adapters, power and signal can be concurrently transmitted by using only one integrated power/signal transmission line 30″. Thus, the appearance of the system is made simpler, and there is no need to add an external circuit for concurrently transmitting power and signal.

In above embodiments of the invention, the power transmission line can detachably connect the body and the base, not only saving packaging space but also reducing delivery cost. Furthermore, the design of disposing the transformer inside the supporting part avoids the disadvantages of a conventional external transformer such as having heavier weight, occupying larger space and lacking aesthetic attraction. The computer screen disclosed in the embodiments of invention increases overall aesthetics, reduces cost, improves convenience of use and enhances market competiveness.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer screen, comprising:
a body, comprising a display panel;
a base comprising a connecting part, a supporting part, and a transformer, wherein the body is detachably disposed on the base, the transformer, connected to an alternating current (AC) power source for electrically connecting the body selectively, is disposed inside the supporting part for transforming an AC voltage of the AC power source to a direct current (DC) voltage, and the connecting part detachably connects the body and the supporting part; and
a power transmission line detachably connecting the body and the supporting part for transmitting the DC voltage to the body.

2. The computer screen according to claim 1, wherein the power transmission line is detachably buried in the connecting part.

3. The computer screen according to claim 1, wherein a surface of the connecting part has a groove in which the power transmission line is detachably embedded.

4. The computer screen according to claim 1, wherein the body comprises an image processing plate, which processes an image display signal and displays the processed image display signal on the display panel.

5. The computer screen according to claim 1, further comprising an image processing plate, wherein the image processing plate is disposed inside the supporting part for processing an image display signal and transmitting the processed image display signal to the body through an image transmission line.

6. The computer screen according to claim 5, further comprising an antenna component, wherein the antenna component is disposed inside the supporting part and electrically connected to the image processing plate.

7. The computer screen according to claim 1, further comprising a first adapter and a second adapter, wherein the first adapter and the second adapter are disposed on the body and the supporting part, respectively, and the power transmission line detachably connects the first adapter and the second adapter, respectively.
